(19) United States
(12) Patent Application Publication
(10) Pub. No.: US 2015/0156228 A1
(43) Pub. Date: Jun. 4, 2015

(54) SOCIAL NETWORKING INTERACTING SYSTEM

(71) Applicant: RONALD LANGSTON, Toledo, OH (US)

(72) Inventor: RONALD LANGSTON, Toledo, OH (US)

(21) Appl. No.: 14/543,996

(22) Filed: Nov. 18, 2014

Related U.S. Application Data
(60) Provisional application No. 61/962,874, filed on Nov. 18, 2013.

(51) Int. Cl. H04L 29/06; G06F 3/0484

(52) U.S. Cl. CPC H04L 65/403; G06F 3/04842

(57) ABSTRACT

A computer-implemented is described. The method can include receiving, at a computing device having one or more processors, a first input from a first user. The first input can be indicative of a first avatar representing the first user. The method can also include receiving, at the computing device, a second input from a second user. The second input can be indicative of a second avatar representing the second user. The method can also include receiving, at the computing device, a third input from one of the first user and the second user. The third input can be indicative of a primary virtual environment for the first avatar and the second avatar. The method can also include outputting, at the computing device, a first video to the first user of the primary virtual environment. The first video can be representative of a first first-person viewpoint of the primary virtual environment. The method can also include outputting, at the computing device, a second video to the second user of the primary virtual environment. The second video can be representative of a second first-person viewpoint of the primary virtual environment different than the first first-person viewpoint. The method can also include including, at the computing device, only nonstrategic content in the first video and the second video.

### CROSS-REFERENCE TO RELATED APPLICATIONS

This application claims the benefit of U.S. Provisional Patent Application Ser. No. 61/962,874 for a SOCIAL NETWORKING INTERACTING SYSTEM, filed on Nov. 18, 2013, which is hereby incorporated by reference in its entirety.

### BACKGROUND

1. Field

The present disclosure relates to a system permitting interaction between two people remotely located from one another.

2. Description of Related Prior Art

U.S. Pat. No. 8,521,817 discloses a SOCIAL NETWORK SYSTEM AND METHOD OF OPERATION. The method is of forming unique, private, personal, virtual social networks on a social network system that includes a database storing data relating to corresponding user entities. The method includes: a first user entity sending an invitation to a second user entity, recording in the database the second user entity as a direct contact of the first user entity and determining that third user entities, directly connected to the second user entity, are indirect contacts. A unique, personal, social network formed from direct and indirect contacts is thereby created for each user entity. Each user entity is able to control privacy of its data with respect to other user entities depending on the connection factor to that other entity and/or that other entity's attributes. Each user entity is able to take the role of provider or participant in applications where the provider provides an item or service to the participant.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computer-implemented is described. The method can include receiving, at a computing device having one or more processors, a first input from a first user. The first input can be indicative of a first avatar representing the first user. The method can also include receiving, at the computing device, a second input from a second user. The second input can be indicative of a second avatar representing the second user. The method can also include receiving, at the computing device, a third input from one of the first user and the second user. The third input can be indicative of a primary virtual environment for the first avatar and the second avatar. The method can also include outputting, at the computing device, a first video to the first user of the primary virtual environment. The first video can be representative of a first first-person viewpoint of the primary virtual environment. The method can also include outputting, at the computing device, a second video to the second user of the primary virtual environment. The second video can be representative of a second first-person viewpoint of the primary virtual environment different than the first first-person viewpoint. The method can also include including, at the computing device, only nonstrategic content in the first video and the second video.

### BRIEF DESCRIPTION OF THE DRAWINGS

The detailed description set forth below references the following drawings:

FIG. 1 is a diagram of a computing system including an example computing device according to some implementations of the present disclosure;

FIG. 2 is a functional block diagram of the example computing device of FIG. 1;

FIG. 3 is a view of a display resulting from an output at the example computing device of FIG. 1 displaying options to a user for creating an avatar, establishing attributes, and limiting permissions associated with search queries of other users;

FIG. 4 is a view of a display resulting from an output at the example computing device of FIG. 1 displaying information associated with a request from one user to another user to meet and share a primary virtual environment;

FIG. 5 is a view of a display resulting from an output at the example computing device of FIG. 1 displaying a first entry virtual environment and an avatar in the first entry virtual environment;

FIG. 6 is a view of a display resulting from an output at the example computing device of FIG. 1 displaying a second entry virtual environment and an avatar in the second entry virtual environment;

FIG. 7 is a view of a display resulting from an output at the example computing device of FIG. 1 displaying a first primary virtual environment and an avatar in the first primary virtual environment;

FIG. 8 is a view of a display resulting from an output at the example computing device of FIG. 1 displaying a second primary virtual environment and an avatar in the second primary virtual environment; and

FIG. 9 is a flow diagram of an example method according to the present disclosure.

### DETAILED DESCRIPTION

A plurality of different embodiments of the present disclosure is shown in the Figures of the application. Similar features are shown in the various embodiments of the present disclosure. Similar features across different embodiments have been numbered with a common reference numeral and have been differentiated by an alphabetic suffix. Similar features in a particular embodiment have been numbered with a common two-digit, base reference numeral and have been differentiated by a different leading numeral. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

The present disclosure, as demonstrated by the exemplary embodiments described below, can provide a system allowing users remotely-located from one another to concurrently experience a virtual environment. The virtual environment can include nonstrategic content such that the users experience entertainment and can focus on one another, rather than focusing on achieving a predetermined accomplishment or outcome. Embodiments of the present disclosure can be carried out on computing devices possessed by users. A computing device can be a desktop computer, a laptop computer, a tablet computer, mobile phones, and/or a video game console.

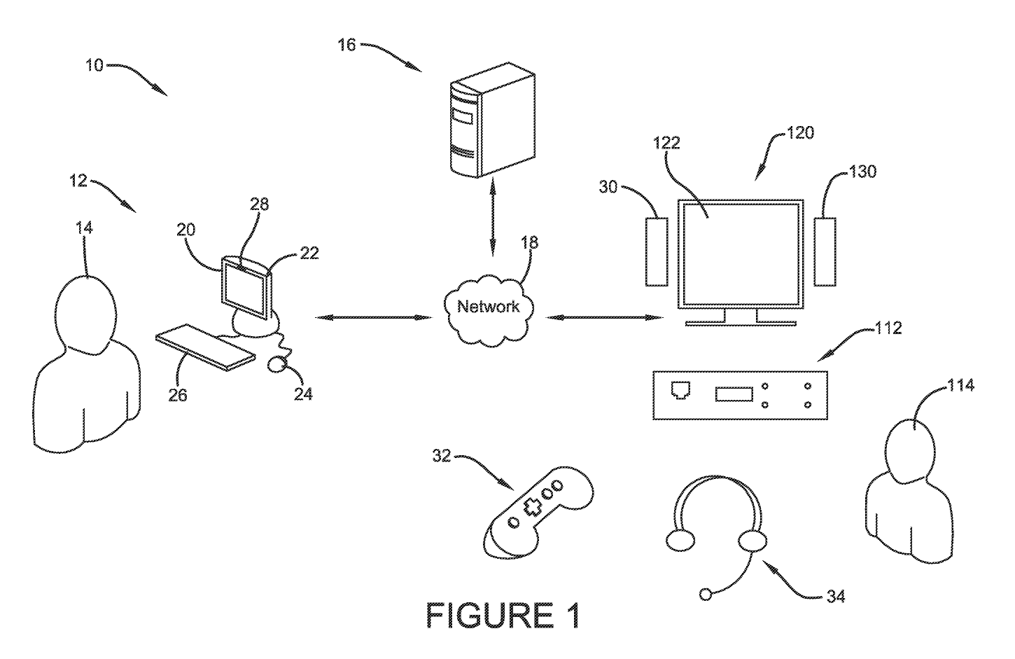

Referring now to FIG. 1, a diagram of an example computing system 10 is illustrated. The computing system 10 can include a computing device 12 that is operated by a first user such as user 14. The computing device 12 can be configured to communicate with a computing device 16 via a network 18. Examples of the computing device 12 include desktop computers, laptop computers, tablet computers, mobile phones, and video game consoles. In some embodiments, the computing device 12 can be a video game console device associated with the user 14. In some embodiments, the computing device 16 can be a server or more than one server operating cooperatively. The network 18 can include a local area network (LAN), a wide area network (WAN), e.g., the Internet, or a combination thereof

In some implementations, the computing device 12 includes peripheral components. The computing device 12 can include display 20 having display area 22. In some implementations, the display 20 is a touch display. The computing device 12 can also include other input devices, such as a mouse 24, a keyboard 26, and a microphone 28.

In some implementations, the computing device 112 includes peripheral components. The computing device 112 can be operated by a second user such as user 114. The computing device 112 can include display 120 having display area 122. In some implementations, the display 120 is a television engaged and the computing device 112 is a video game console. The computing device 112 can also include other input devices, such as speakers 30, 130, a controller 32, and a headset microphone 34.

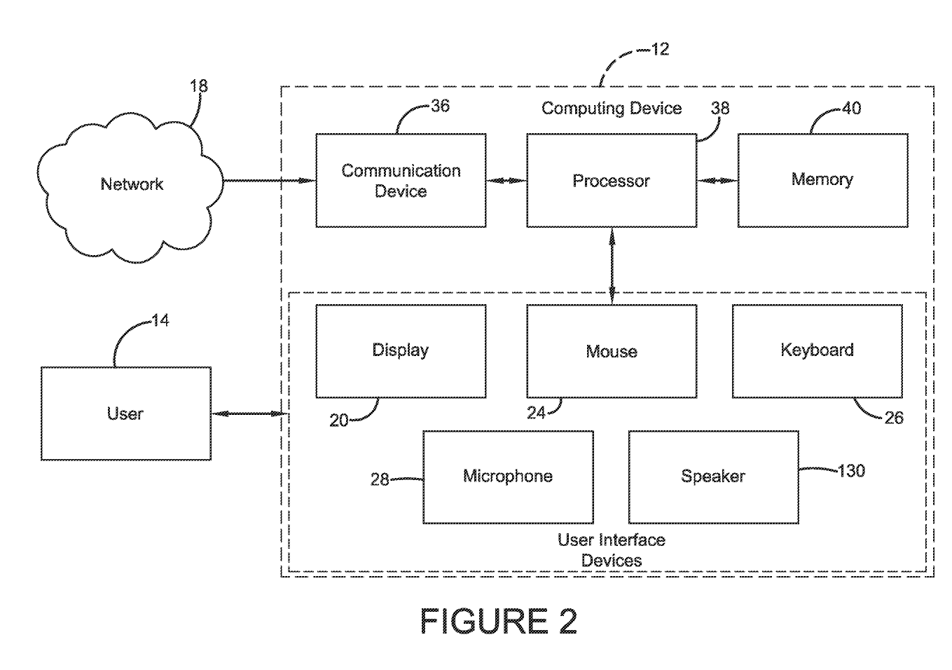

Referring now to FIG. 2, a functional block diagram of one example computing device 12 is illustrated. While a single computing device 12 and its associated user 14 and example components are described and referred to hereinafter, it should be appreciated that computing devices 12, 16, 112 can have the same or similar configuration and thus can operate in the same or similar manner. Further, the computing devices 12, 16 and 112 can cooperatively define a computing device according to the present disclosure. The computing device 12 can include a communication device 36, a processor 38, and a memory 40. The computing device 12 can also include the display 20, the mouse 24, the keyboard 26, and the microphone 28 (referred to herein individually and collectively as “user interface devices”). The user interface devices are configured for interaction with the user 14. The computing device 12 can also include a speaker 130 (not referenced in FIG. 1).

The communication device 36 is configured for communication between the processor 38 and other devices, e.g., the other computing device 16, via the network 18. The communication device 36 can include any suitable communication components, such as a transceiver. Specifically, the communication device 36 can transmit inputs from the first and second users 14, 114 to the computing device 16 for processing and can provide responses to such inputs to the processor 38. The communication device 36 can then handle transmission and receipt of the various communications between the computing devices 12 and 16, as well as between computing devices 112 and 16, during interactions between the users 14, 114 in some embodiments of the present disclosure. The memory 40 can be configured to store information at the computing device 12, including video files and sound files representative of one or more avatars representing users, user profiles and preferences, and one or more virtual environments for users to experience. The memory 40 can be any suitable storage medium (flash, hard disk, etc.).

The processor 38 can be configured to control operation of the computing device 12. It should be appreciated that the term “processor” as used herein can refer to both a single processor and two or more processors operating in a parallel or distributed architecture. The processor 38 can be configured to perform general functions including, but not limited to, loading/executing an operating system of the computing device 12, controlling communication via the communication device 36, and controlling read/write operations at the memory 40. The processor 38 can also be configured to perform specific functions relating to at least a portion of the present disclosure including, but not limited to, loading/executing virtual environments at the computing device 12, communicating audio between multiple users, and controlling the display 20, including creating and modifying a user interface, which is described in greater detail below.

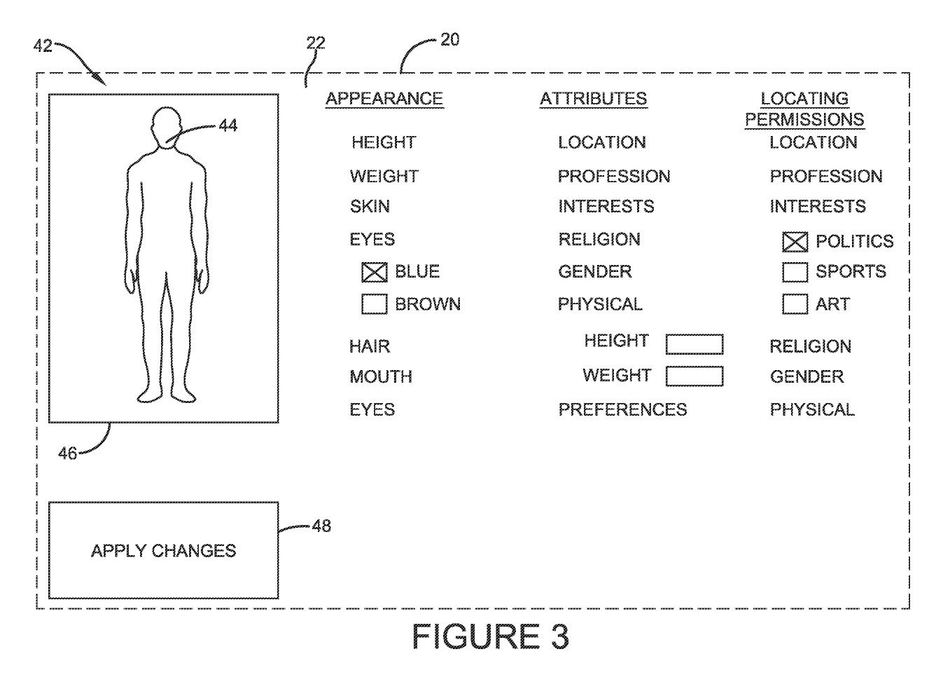

Referring now to FIG. 3, a diagram of the display 20 of an example computing device 12 is illustrated. The computing device 12 can load and execute a social networking interacting system application 42, which is illustrated by a user interface displayed in the display area 22 of the display 20. The application 42 may not occupy the entire display area 22, e.g., due to toolbars or other borders (not shown). The application 42 can be configured to initiate an interactive session between two users, which can include displaying prompts.

FIG. 3 is a view of a display resulting from an output at the example computing device of FIG. 1 displaying options to a user for creating an avatar, establishing attributes, and limiting permissions associated with search queries of other users. Through the user interface displayed in FIG. 3, the computing device 12 can receive an input indicative of a desired appearance of an avatar 44, shown in a portion 46 of the display area 22. By selecting an option, the computing device 12 can cause a submenu or pull down menu to appear. In the exemplary display, the user has selected blue eyes for the avatar 44. The input can also be indicative of attributes of the user. The attributes can include preferences of the first user relative to other users. The input can also be indicative of limiting permissions associated with search queries of other users. For example, the first user can prevent the second user from finding him/her during searching by the second user unless the second user has one or more particular attributes. After initially setting-up an avatar, attributes and locating permissions, the user can select a button 48 and this data can be stored in memory 40.

The computing device 12 can be operable to receive an input from a user indicative of a search query of other users. The computing device 12 can permit the user to search based on one or more attributes of other users. In response to receiving an input from a user indicative of a search query of other users, the computing device 12 can search memory 40, extract user profiles matching the query and granting permission based on the attributes of the first user, and display the profile names and attributes of the search results to the first user.

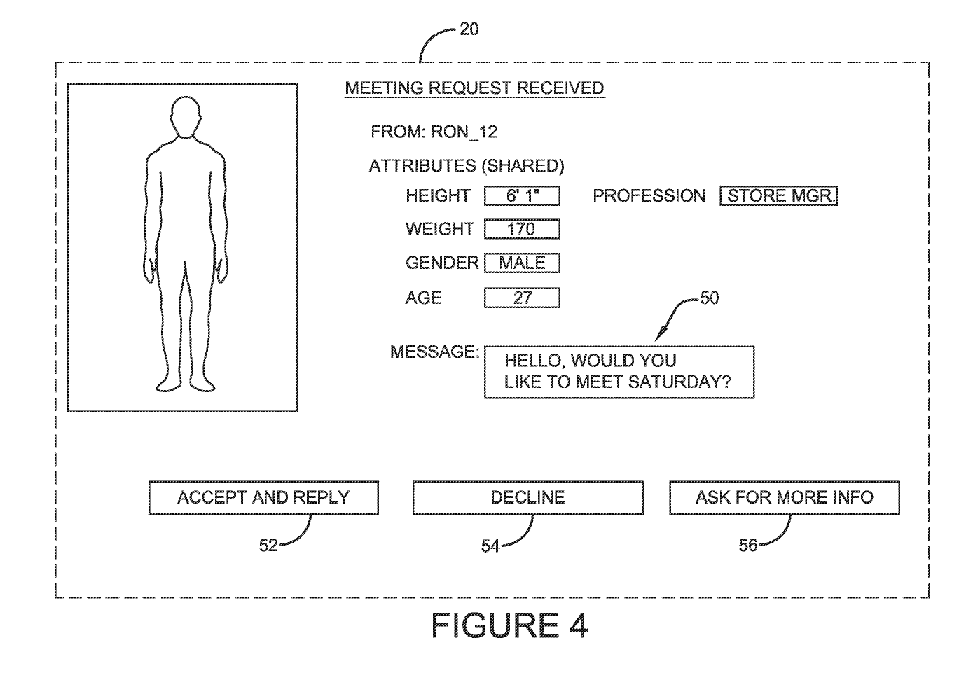

FIG. 4 is a view of a display resulting from an output at the example computing device of FIG. 1 displaying information associated with a request from one user to another user to meet and share a primary virtual environment. The example display is output to the display 20 in response to the computing device 12 receiving an input from a user. For example, the first user 14 can search for another user to share a primary virtual environment. Based on the search query, the computing device 12 can suggest the second user 114. The computing device 12 can communicate a message from the first user to the second user. The input from the first user can be representative of a request to jointly participate in the primary virtual environment. As shown in FIG. 4, the second user can receive an output from the computing device 12 and the display 20 can display the message from the first user, as referenced at 50. The computing device 12 can control the display 20 to display attributes of the user initiating the message 50. The users can remain anonymous with respect to one another during interactions through the system 10. The second user can be presented with buttons 52, 54, 56 associated with various kinds of responses to the message from the first user.

By selecting the button 52, the computing device 16 can receive an input from the second user 114 indicative of acceptance of the message request from the first user 14. At the agreed-upon time between the first user 14 and the second user 114, the computing device 16 can output a third video to the first user 14 of an entry virtual environment. The third video can be displayed on the display 20 of the computing device 12. The third video can be representative of a first-person viewpoint of the entry virtual environment. The entry virtual environment can display one or more representations of primary virtual environments available to the first user and the second user. The computing device 16 can also output a fourth video to the second user 114 of the entry virtual environment. The fourth video can be representative of a first-person viewpoint of the entry virtual environment. The third and fourth videos can be different visual perspectives of the same entry virtual environment.

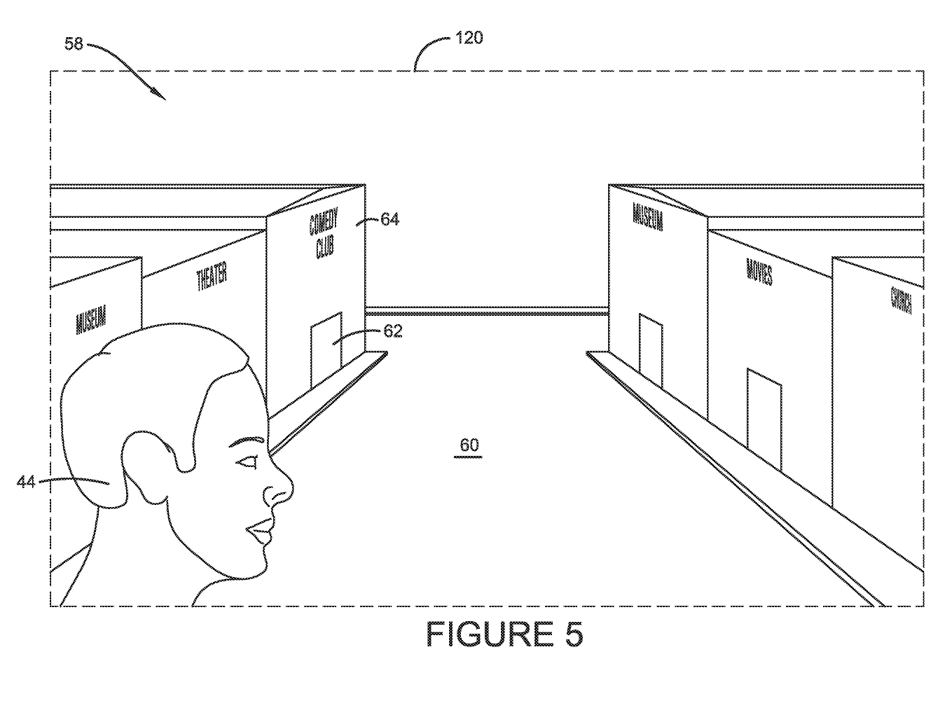

FIG. 5 is a view of a display resulting from an output at the example computing device 16 of FIG. 1 displaying a first entry virtual environment 58 and an avatar in the first entry virtual environment 58. The display 120 can be controlled by the computing device 16 to display the first entry virtual environment shown in FIG. 5. The avatar 44 of the first user 14 can be shown in the display 120 of the second user 114, the avatar 44 shown within the first entry virtual environment 58. Similarly, the computing device 16 can control the display 20 of the first user 14 to display the first entry virtual environment 58 from a different visual perspective and show the avatar of the second user 114 within the first entry virtual environment 58.

The example first entry virtual environment 58 can display one or more primary virtual environments available to the first user and the second user. The example first entry virtual 58 environment can be a street 60 of a town. The one or more primary virtual environments can be represented as stores along the street 60. One or both of the users 14, 114 can move their avatars to the door of one of the stores to enter a desired primary virtual environment. As will be discussed in greater detail below, the system 10 can allow the users 14, 114 to verbally communicate in real time to make a joint decision. For example, if the users 14, 114 wish to share the experience of a comedy club, one or both of the users 14, 114 can control their avatar to move and pass through a door 62 of the comedy club 64.

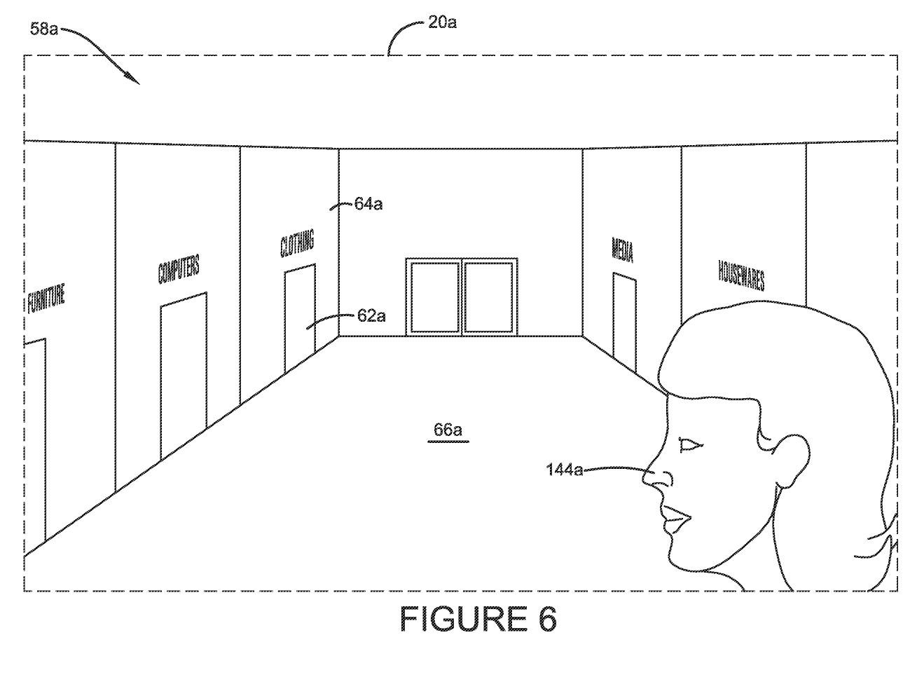

FIG. 6 is a view of a display 20a of the first user resulting from an output at the example computing device 16 of FIG. 1 displaying a second entry virtual environment 58a and an avatar 144a in the second entry virtual environment 58a. The example second entry virtual environment 58a can display one or more primary virtual environments available to the first user and the second user. The example second entry virtual environment 58a can be a mall 66a. The one or more primary virtual environments can be represented as stores in the mall 66a. One or both of the users can move their avatars to the door of one of the stores to enter a desired primary virtual environment. As will be discussed in greater detail below, the system 10 can allow the users to verbally communicate in real time to make a joint decision. For example, if the users wish to share the experience of browsing or shopping for clothing, one or both of the users can control their avatar to move and pass through a door 62a of the clothing store 64a.

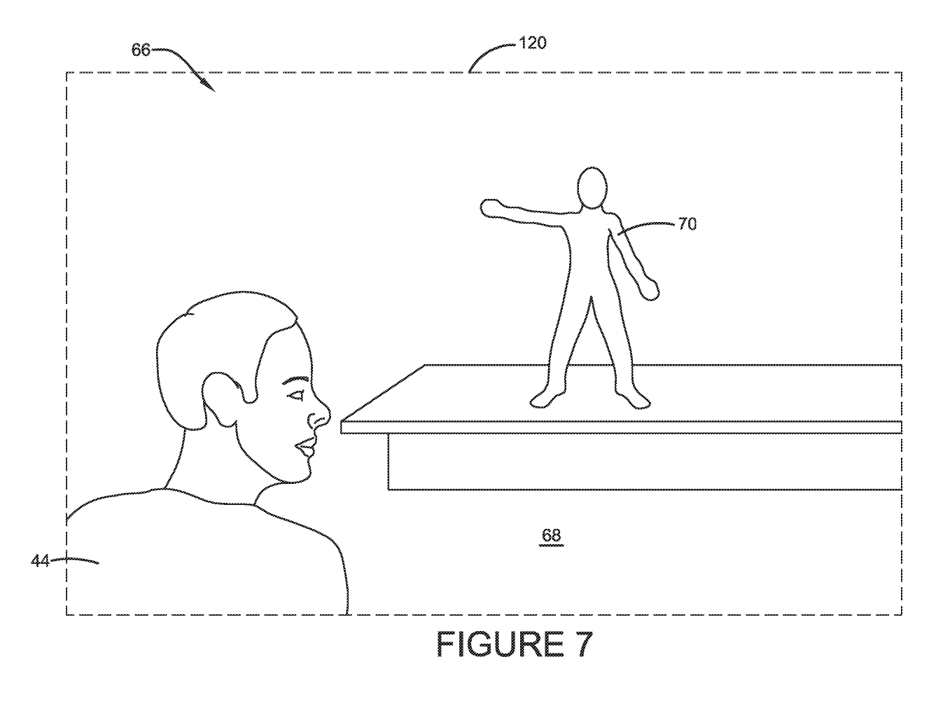

After receiving an input indicating the desired primary virtual environment, the computing device 16 can output respective videos to the first and second users 14, 114. A first video can be output to the first user 14 and can be representative of a first first-person viewpoint of the primary virtual environment. a second video can be output to the second user 114 and can be representative of a second first-person viewpoint of the primary virtual environment different than the first first-person viewpoint. FIG. 7 shows an example second video displayed on the display 120 of the second user 114. The display 120 can be controlled by the computing device 16 to display a first primary virtual environment 66 being a comedy club 68. The first video displayed to the first user can also display the comedy club 68 from a different visual perspective. The first video and the second video can include a performance of a comedian referenced at 70. The avatar 44 of the first user 14 can be displayed in the second video with the first primary virtual environment 66 and the avatar of the second user 114 can be displayed in the first video.

The primary virtual environment and the first and second videos associated with the primary virtual environment can include only nonstrategic content. Substantially similar nonstrategic content can be included in the first video and the second video. Nonstrategic content can be further defined as content that is observable and can progress to completion without requiring further input from either of the first user or second user. Nonstrategic content can also be defined as content such that the computing device does require a series of maneuvers or stratagems from either the first user or the second user for obtaining a specific goal or result after receiving the third input. Nonstrategic content can allow the user to be passive, quiescent, and uninvolved with the computing device 16. The first and second videos can be for display and not define a game.

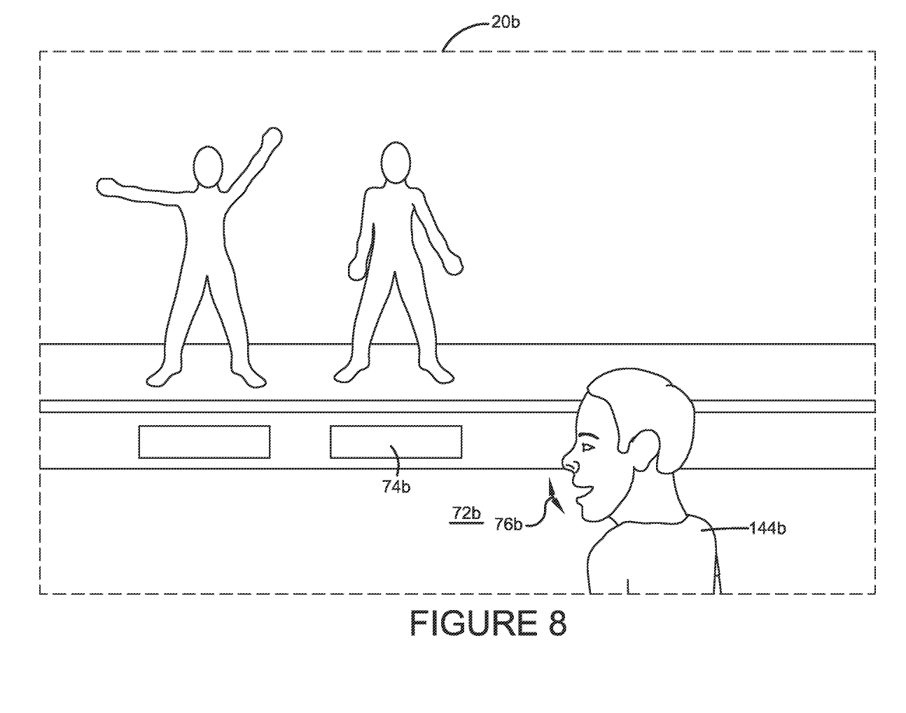

The computing device 16 can store a plurality of different primary virtual environments having only nonstrategic content. A second primary virtual environment can be a museum wherein the first video and second video include a sequential display of paintings. As shown in FIG. 8, a third primary virtual environment can be a theater 72b. The first video and second video can include a performance of a play. The avatar 144b of the second user 114 is shown in theater 72b as displayed to the first user 14 through the display 20b. A fourth primary virtual environment can be a movie theater wherein the first video and second video include playing of a movie. A fifth primary virtual environment can be a church wherein the first video and second video include a presentation of a sermon. A sixth primary environment can be a natural environment such as a park or a beach. Advertising can be included in the first video and the second video, as referenced by example in FIG. 8 at 74b.

The computing device 16 can also receive an input being a voice input. The computing device 16 can receive a first input being a voice of the first user 14. The computing device 16 can also receive a second input being a voice of the second user 114. The voice inputs can be received as first video and second video are being output. The computing device 16 can output first audio to the first user during outputting of the first video, the first audio being the voice input received from the second user. The computing device 16 can also output second audio to the second user during outputting of the second video, the second audio being the voice input received from the first user. The first audio and the second audio can be output concurrently and in real-time. Thus, the first and second users 14, 114 can discuss the content of the primary virtual environment. The focus of the interaction is not problem solving or game play, but communication with one another.

During the exchange of voice inputs, the computing device can modify a display of the avatars. For example, the avatars can be displayed as talking when the corresponding user is talking. This is shown in FIG. 8 by movement of the jaw of the avatar 114b, referenced at 76b.

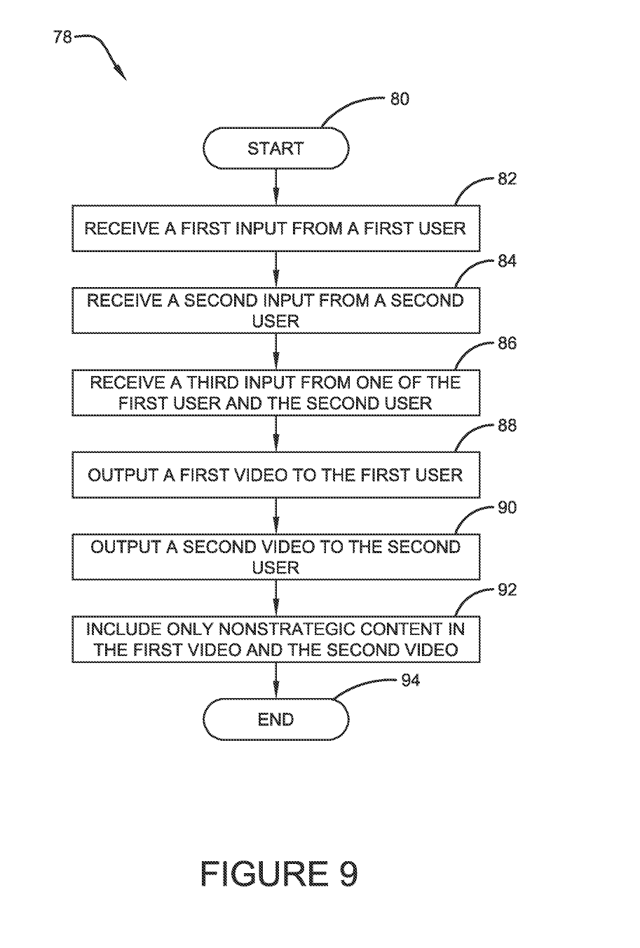

Referring now to FIG. 9, a flow diagram of an example method 78 for assisting first and second users 14, 114 in interacting with the application 42 is illustrated. For ease of description, the method 78 will be described in reference to being performed by a computing device 16, but it should be appreciated that the method 78 can be performed by computing device 12, computing device 112, performed by two or more computing devices operating in a parallel or distributed architecture, and/or any one or more particular components of one or a plurality of computing devices.

The method starts at 80. At 82, the computing device 16 can receive a first input from a first user. The first input can be indicative of a first avatar representing the first user. At 84, the computing device 16 can receive a second input from a second user. The second input can be indicative of a second avatar representing the second user. At 86, the computing device 16 can receive a third input from one of the first user and the second user. The third input can be indicative of a primary virtual environment for the first avatar and the second avatar.

At 88, the computing device 16 can output a first video to the first user of the primary virtual environment. The first video can be representative of a first first-person viewpoint of the primary virtual environment. At 90, the computing device 16 can output a second video to the second user of the primary virtual environment. The second video can be representative of a second first-person viewpoint of the primary virtual environment different than the first first-person viewpoint. At 92, the computing device can include only nonstrategic content in the first video and the second video. The method ends at 94.

In some embodiments of the present disclosure, a motion sensor can be coupled to a computing device. The motion sensor can detect movement of a user. In response, the computing device can cause the display of the avatar associated with that user to move. For example, if the virtual environment is a dance club, movement of the user will result in movement of avatar in the dance club.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

While the present disclosure has been described with reference to an exemplary embodiment, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the appended claims. Further, the “present disclosure” as that term is used in this document is what is claimed in the claims of this document. The right to claim elements and/or sub-combinations that are disclosed herein as other present disclosures in other patent documents is hereby unconditionally reserved.

What is claimed is:

1. A computer-implemented method, comprising:
receiving, at a computing device having one or more processors, a first input from a first user, the first input indicative of a first avatar representing the first user;
receiving, at the computing device, a second input from a second user, the second input indicative of a second avatar representing the second user;
receiving, at the computing device, a third input from one of the first user and the second user, the third input indicative of a primary virtual environment for the first avatar and the second avatar;
outputting, at the computing device, a first video to the first user of the primary virtual environment, the first video representative of a first first-person viewpoint of the primary virtual environment;
outputting, at the computing device, a second video to the second user of the primary virtual environment, the second video representative of a second first-person viewpoint of the primary virtual environment different than the first first-person viewpoint; and
including, at the computing device, only nonstrategic content in the first video and the second video.

2. The computer-implemented method of claim 1 wherein including nonstrategic content is further defined as:
including, at the computing device, substantially similar nonstrategic content in the first video and the second video.

3. The computer-implemented method of claim 2 wherein including nonstrategic content is further defined as:
including, at the computing device, the content in the first video and the second video such that the content is observable and progresses to completion without requiring further input from either of the first user or second user.

4. The computer-implemented method of claim 2 wherein including nonstrategic content is further defined as:
including, at the computing device, the content in the first video and the second video such that the computing device does require a series of maneuvers or stratagems from either the first user or the second user for obtaining a specific goal or result after receiving the third input.

5. The computer-implemented method of claim 1 further comprising:
receiving, at the computing device, a fourth input from the first user, the fourth input being a voice input including a voice of the first user, the fourth input received during outputting of the first video having nonstrategic content;
receiving, at the computing device, a fifth input from the second user, the fifth input being a voice input including a voice of the second user, the fifth input received during outputting of the second video having nonstrategic content;
outputting, at the computing device, first audio to the first user during outputting of the first video having nonstrategic content, the first audio being the fifth input received from the second user; and
outputting, at the computing device, second audio to the second user during outputting of the second video having nonstrategic content, the second audio being the fourth input received from the first user.

6. The computer-implemented method of claim 5 further comprising:
including, at the computing device, the second avatar in the first video; and
modifying, at the computing device, a display of the second avatar in the first video in response to receiving the fifth input, the display of the second avatar modified such that the second avatar is displayed as talking in the first video during outputting of the first audio to the first user.

7. The computer-implemented method of claim 5 further comprising:
outputting, at the computing device, the first audio and the second audio concurrently.

8. The computer-implemented method of claim 1 further comprising:
storing, at the computing device, a plurality of different primary virtual environments having only nonstrategic content.

9. The computer-implemented method of claim 8 wherein storing further comprises:
storing, at the computing device, at least one of a first primary virtual environment being a comedy club wherein the first video and second video include a performance of a comedian, a second primary virtual environment being a museum wherein the first video and second video include a sequential display of paintings, a third primary virtual environment being a theater wherein the first video and second video include a performance of a play, a fourth primary virtual environment being a theater wherein the first video and second video include playing of a movie, and a fifth primary virtual environment being a church wherein the first video and second video include a presentation of a sermon.

10. The computer-implemented method of claim 1 further comprising:
including, at the computing device, advertising in the first video and the second video.

11. The computer-implemented method of claim 1 further comprising:
outputting, at the computing device, an entry virtual environment to the first user and the second user before receiving the third input, the entry virtual environment displaying one or more primary virtual environments available to the first user and the second user, the entry virtual environment being a mall and the one or more primary virtual environments being represented as stores in the mall.

12. The computer-implemented method of claim 1 further comprising:
outputting, at the computing device, an entry virtual environment to the first user and the second user before receiving the third input, the entry virtual environment displaying one or more primary virtual environments available to the first user and the second user, the entry virtual environment being a street of a town and the one or more primary virtual environments being represented as stores along the street.

13. The computer-implemented method of claim 1 further comprising:
receiving, at the computing device, a sixth input from the first user, the sixth input indicative of attributes of the first user, the attributes including preferences of the first user relative to other users.

14. The computer-implemented method of claim 13 further comprising:
receiving, at the computing device, a seventh input from the first user, the seventh input indicative of a search query of other users.

15. The computer-implemented method of claim 14 wherein receiving the sixth input is further defined as:
receiving, at the computing device, the sixth input from the first user, the sixth input indicative of attributes of the first user, the attributes including limiting permissions associated with search queries of other users.

16. The computer-implemented method of claim 1 further comprising:
receiving, at the computing device, an eighth input from the first user, the eighth input indicative of a message from the first user to the second user, the eighth input received before the third input, and the eighth input representative of a request to jointly participate in the primary virtual environment; and
outputting, at the computing device, a message request output to the second user in response to receiving the eighth input from the first user.

17. The computer-implemented method of claim 16 further comprising:
receiving, at the computing device, a ninth input from the second user, the ninth input indicative of acceptance of the message request output; and
outputting, at the computing device, a message output to the second user in response to receiving the ninth input from the second user, the message output representative of the eighth input.

18. The computer-implemented method of claim 17 further comprising:
outputting, at the computing device, a third video to the first user of an entry virtual environment different than the primary virtual environment, the third video representative of a third first-person viewpoint of the entry virtual environment, the entry virtual environment displaying one or more representations of primary virtual environments available to the first user and the second user;
outputting, at the computing device, a fourth video to the second user of the entry virtual environment, the fourth video representative of a fourth first-person viewpoint of the entry virtual environment; and
wherein receiving, at the computing device, the third input occurs after outputting the third video and outputting the fourth video.

19. The computer-implemented method of claim 1 further comprising:
including, at the computing device, the second avatar in the first video; and
including, at the computing device, the first avatar in the second video.

20. A computing device, comprising:
one or more processors; and
a non-transitory, computer readable medium storing instructions that, when executed by the one or more processors, cause the computing device to perform operations comprising:
receiving a first input from a first user, the first input indicative of a first avatar representing the first user;
receiving a second input from a second user, the second input indicative of a second avatar representing the second user;
receiving a third input from one of the first user and the second user, the third input indicative of a primary virtual environment for the first avatar and the second avatar;
outputting a first video to the first user of the primary virtual environment, the first video representative of a first first-person viewpoint of the primary virtual environment;
outputting a second video to the second user of the primary virtual environment, the second video representative of a second first-person viewpoint of the primary virtual environment different than the first first-person viewpoint; and
including only nonstrategic content in the first video and the second video.
